(19) United States
(12) Patent Application Publication
(10) Pub. No.: US 2023/0150683 A1
(43) Pub. Date: May 18, 2023

(54) ELECTRIC MACHINE

(71) Applicant: ROLLS-ROYCE plc, London (GB)

(72) Inventor: Ellis F H CHONG, Derby (GB)

(73) Assignee: ROLLS-ROYCE plc, London (GB)

(21) Appl. No.: 18/051,113

(22) Filed: Oct. 31, 2022

(30) Foreign Application Priority Data
Nov. 16, 2021 (GB) 2116498.3

(51) Int. Cl. B64D 33/08; B64D 27/24; H02K 9/19; H02K 1/20

(52) U.S. Cl. CPC B64D 33/08; B64D 27/24; H02K 9/19; H02K 1/20

(57) ABSTRACT

An electric machine comprises a stator winding located within a stator housing. The stator housing comprises an inlet chamber configured to communicate with a supply of coolant, and an outlet. The stator housing contains a baffle configured to separate the stator winding and outlet from the inlet chamber. The baffle includes at least one aperture therethrough configured to supply an impingement flow of coolant to the stator winding.

### CROSS-REFERENCE TO RELATED PATENT APPLICATIONS

This application is based upon and claims the benefit of priority from British Patent Application No. GB 2116498.3, filed on Nov. 16, 2021, the entire contents of which are herein incorporated by reference.

### BACKGROUND

### Technical Field

The present disclosure concerns an electric machine suitable for an aircraft propulsion system, and a propulsion system comprising the electric machine.

### Description of Related Art

Electric machines can take the form of either generators, which convert mechanical torque to electrical energy, or motors, which convert electrical energy to mechanical torque. In either case, it is desirable to provide electric machines having a high power density, i.e. a high power per unit mass or volume. Such high power densities are particularly useful for applications such as aircraft propulsion systems, where both high power and low mass are desirable.

Such high power densities can result in cooling challenges. In particular, it can be difficult to provide sufficient coolant flow at a sufficiently low temperature to maintain low electric machine temperatures during use, where the electric machine has a physically small volume. Such problems are exacerbated where the coolant comprises a gaseous coolant such as air, which has a low heat transfer coefficient.

### SUMMARY

The present disclosure seeks to provide an electric machine having improved cooling.

According to a first aspect there is provided an electric machine comprising:

a stator winding located within a stator housing;
the stator housing comprising an inlet chamber configured to communicate with a supply of coolant, and an outlet;
the stator housing comprising a baffle configured to separate the stator winding and outlet from the inlet chamber; wherein
the baffle comprises at least one aperture therethrough configured to supply an impingement flow of coolant to the stator winding.

Advantageously, for a given coolant flow and inlet temperature, the effectiveness of the coolant in reducing stator winding temperatures is increased relative to conventional flood cooling, since the apertures within the baffle direct coolant at higher velocity toward the stator windings, which increases cooling effectiveness.

The baffle may be provided adjacent an end winding of the stator. The baffle may at least partly surround generally opposite sides of the end winding. The baffle may comprise at least one aperture adjacent each side of the end winding.

The stator winding may comprise first and second end windings at opposite sides of the stator housing.

The baffle may be provided adjacent the first end winding, and the outlet may be provided adjacent the second end winding. The stator winding may define a channel through which coolant is configured to flow from the baffle to the outlet.

Alternatively, a first outlet may be provided adjacent a first end winding separated from a first inlet by a first baffle, and a second outlet may be provided at a second end winding separated from a second inlet by a second baffle. The second baffle may comprise an end plate of the stator housing. Advantageously, interference between the baffle and winding terminations is avoided.

The first inlet may be configured to provide a lower coolant flow rate in use relative to the second inlet. The first outlet may be configured to pass a higher coolant flow rate in use relative to the second outlet. The winding may define a channel configured to communicate between the second inlet and first outlet. Consequently, coolant may flow in use from both the first and second inlets and through the stator winding to the first outlet, thereby preventing hot-spots in the winding.

The or each aperture in the or each baffle may comprise a nozzle configured to accelerate flow through the aperture.

According to a second aspect of the invention there is provided an aircraft propulsion system comprising an electric machine in accordance with the first aspect.

The electric machine may comprise one or both of a generator and a motor.

The propulsion system may comprise an internal combustion engine, and the generator may be configured to be driven by the internal combustion engine.

Alternatively or additionally, the propulsion system may comprise a propulsor, and the motor may be configured to drive the propulsor.

The skilled person will appreciate that except where mutually exclusive, a feature described in relation to any one of the above aspects may be applied mutatis mutandis to any other aspect. Furthermore except where mutually exclusive any feature described herein may be applied to any aspect and/or combined with any other feature described herein.

### DESCRIPTION OF THE DRAWINGS

Embodiments will now be described by way of example only, with reference to the Figures, in which:

FIG. 1 is a plan view of an aircraft comprising an electric propulsion system;

FIG. 2 is a cross-sectional side view of the propulsion system of the aircraft of FIG. 1;

FIG. 3 is a cross-sectional view of an electric machine in the form of a motor for use in the propulsion system of FIG. 2;

FIG. 4 is a cross-sectional side view of part of a stator and stator housing of the electric machine of FIG. 3;

FIG. 5 is a perspective side view of a baffle of the electric machine of FIG. 3;

FIG. 6 is a cross-sectional side view of part of a first alternative stator for the electric machine of FIG. 3; and

FIG. 7 is a cross-sectional side view of part of a second alternative stator for the electric machine of FIG. 3.

### DETAILED DESCRIPTION

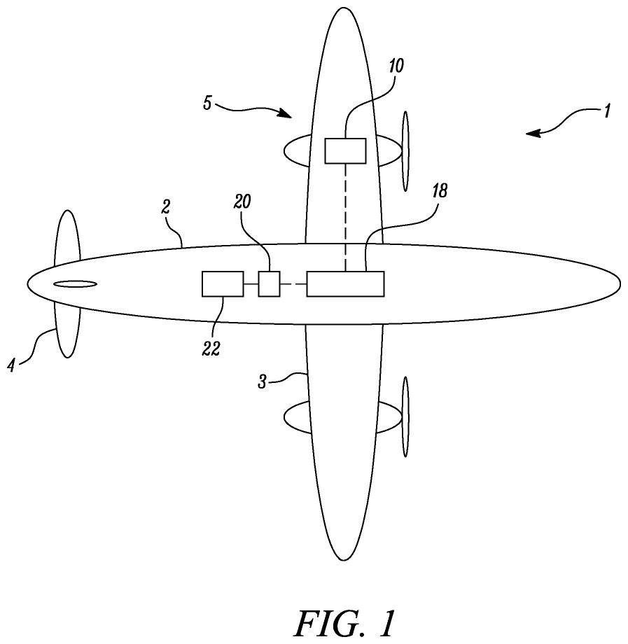

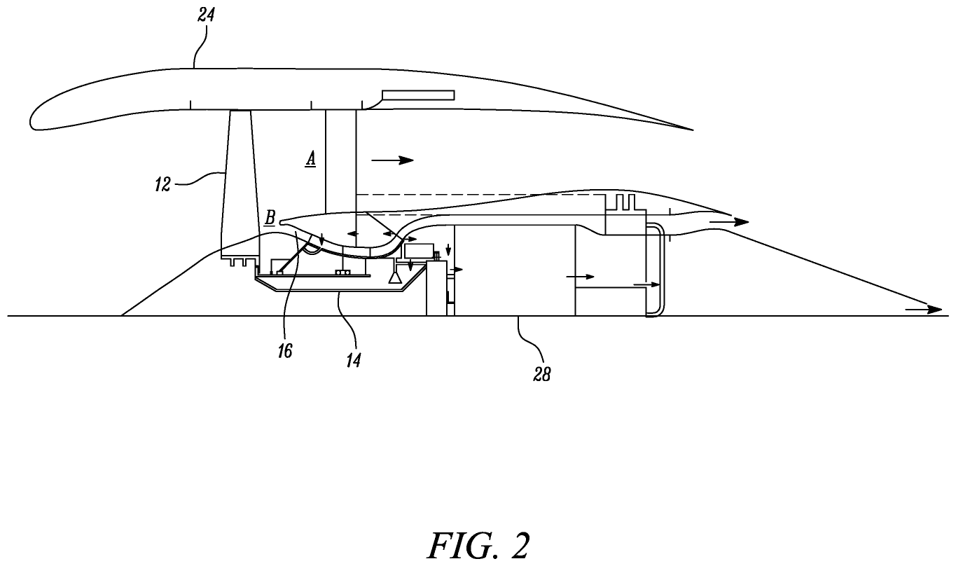

With reference to FIG. 1, an aircraft 1 is shown. The aircraft is of conventional configuration, having a fuselage 2, wings 3, tail 4 and a pair of propulsion systems 5. One of the propulsion systems 5 is shown in figure detail in FIG. 2. Each propulsion system is provided with electrical energy from an energy storage system and/or a generator 20, which may be driven by a prime mover such as a gas turbine engine 22.

FIG. 2 shows the propulsion system 5 schematically. The propulsion system 5

comprises an electrical machine in the form of an electric motor 28 configured to drive a propulsor in the form of a ducted fan 12 via a fan shaft 14. The motor 28 is fed with cooling fluid such as air or liquid coolant via cooling air duct 16, which is provided with pressurised cooling flow from the fan 12. The fan 12 is housed within a nacelle 24.

The motor 28 is of a conventional type, comprising a permanent magnet electric machine, though other types of electric machines could utilise the disclosed cooling arrangement, such as induction machines and brushed machines.

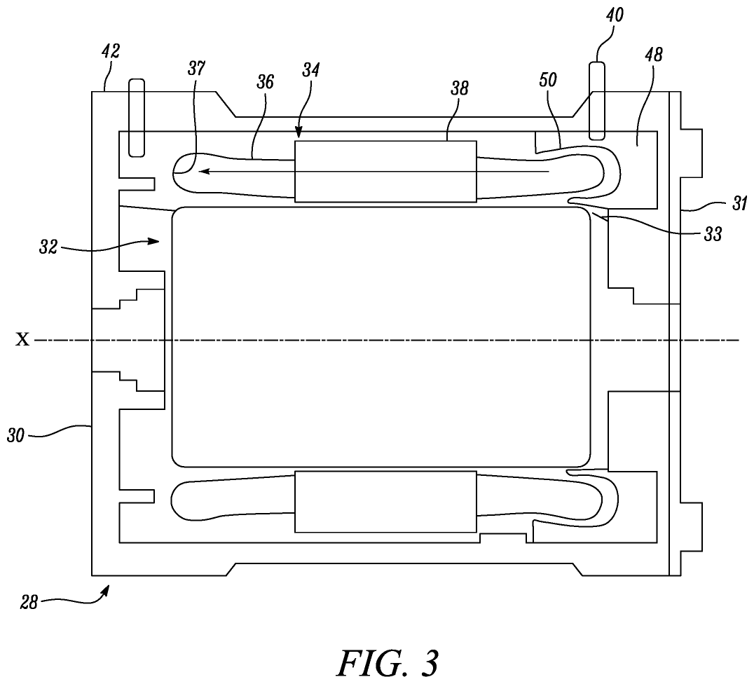

FIG. 3 shows the motor 28 in more detail. The motor 28 comprises a motor housing 30 which houses motor components. The motor housing 30 provides structural support for motor components, and is mounted to structural components of the propulsion system. Additionally, the housing 30 is generally fluid tight, save for openings where coolant ducts and electrical connections are provided.

The motor comprises a rotor 32 which is coupled to the fan shaft 14, and is surrounded by a stator 34, provided radially outward of the rotor 32. The rotor 32 is configured to rotate about an axis X. The stator 34 comprises electrical windings 36, which can be energised to produce a rotating magnetic field. The electrical windings 36 comprise end windings 37, which are provided at axially forward and aft ends of the stator winding 36. This rotating magnetic field interacts with a magnetic field of the rotor 29, to cause rotation when acting as a motor. The windings are wound round a stator core 38, which typically comprises a plurality of laminations made of steel or similar ferromagnetic material.

The motor housing 30 forms a stator housing, which contains the stator 34, including the windings 36 and core 38. A drive plate 31 is provided at an axial end, through which an axle (not shown) extends, for providing motive power. The stator housing 30 is penetrated by a coolant inlet duct 40, and a coolant outlet duct 42. The coolant inlet duct 40 communicates with an inlet chamber in the form of a coolant manifold 44 provided within the stator housing 30. The coolant inlet manifold 48 comprises a space defined by the inner walls of the stator housing 30 and by a baffle 50. The baffle 50 is positioned between the stator end windings 37 and the housing 30, and thereby controls fluid flow between the coolant inlet manifold 48 and stator end windings 37.

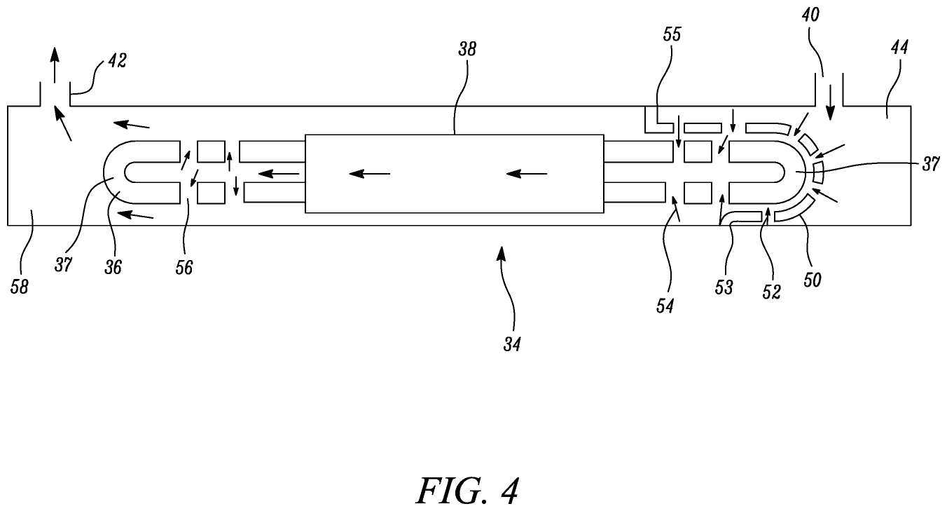

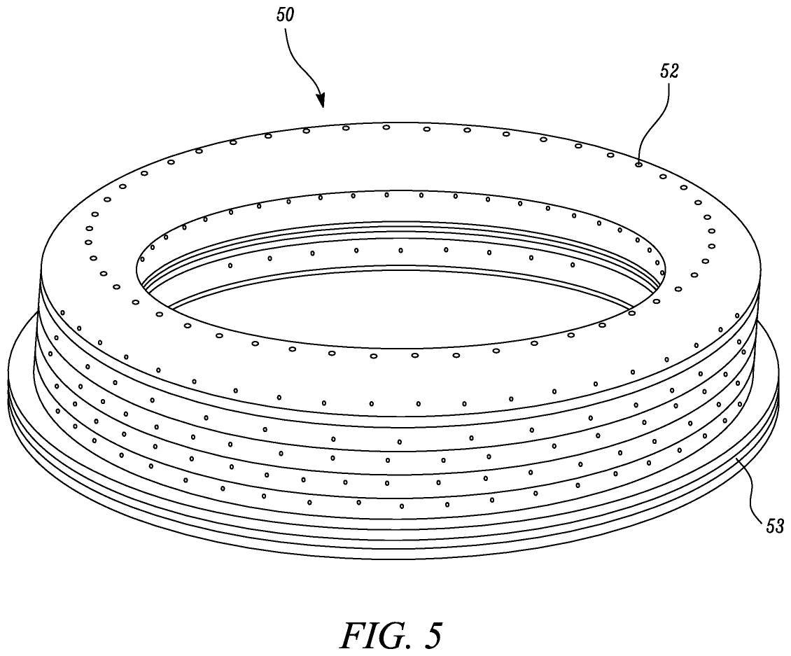

Part of the stator 34 is shown in further detail in FIG. 4. The baffle 50 is shown in further detail in FIG. 5, and is in the form of a ring or toroid which extends around the end windings 37 of the stator. The baffle 50 has a curved profile, which is curved to approximately match the curvature of the end windings 37, is spaced from the end windings 37 in use, and has an open end at an axially extending inward side to accept the end windings 37. Referring again to FIG. 4, seals 53, 55 are provided to seal between the baffle 50 and housing 30. The baffle 50 further comprises a plurality of apertures 52, which extend through the baffle 50 between the inlet manifold 44 and the stator end windings 37. The baffle apertures are distributed about the whole circumference of the baffle ring, and various apertures preferably extend radially inwardly and outwardly, as well as axially, in a direction generally toward the end windings 37. In some cases, the apertures 37 may be shaped to define a convergent nozzle, with the apertures converging in the direction of the end windings 37. In one embodiment, the baffle 50 is formed by Additive Layer Manufacture (ALM) such as Direct Layer Deposition (DLD) to allow for complex nozzle geometries, which may direct coolant flow in desired directions at desired velocities and flow rates. A further plurality of apertures 54 are provided within the stator windings 36. The stator core 38 comprises a hollow portion, through which coolant can flow. Similarly, at the other axial end, further apertures 56 are provided in the stator windings 36, which lead to an outlet manifold 58, which in turn communicates with the coolant outlet 42. A sleeve 33 is provided at each end, to confine the coolant within the stator, and provides a seal between the stator and rotor.

A coolant passageway is therefore defined by the inlet 40, baffle apertures 52, end winding apertures 52, stator core 38, aperture 56, outlet manifold 58 and outlet 42. In use therefore, coolant fluid (in this case air, though liquid coolants such as water and glycol could also be used) flows through the inlet 40, baffle apertures 52, end winding apertures 52, stator core 38, aperture 56, outlet manifold 58 and out the outlet 42, as shown by the arrows in FIG. 4, picking up heat and cooling the stator windings 36 and stator core 38 in use.

It has however been found that particular attention needs to be paid to cooling of the stator end windings 37. These experience high heat loads and temperatures in use, which can lead to failure. The present arrangement provides improved cooling of this area in particular.

As shown by the arrows in FIG. 4, coolant entering the inlet manifold is held back by the baffle 50. The apertures 52 in the baffle 50 act to restrict the flow of coolant, whilst also accelerating the coolant and acting as nozzles, thereby directing coolant to impinge upon the stator end windings.

This direct impingement flow toward the stator end windings 37 has been found to greatly increase cooling effectiveness. Computer Fluid Dynamics (CFD) simulations were performed on a simulated motor. In the simulation, 5 litres/minute of coolant was supplied, which resulted in end winding temperatures of 108° C. In comparison simulations, with the same geometry, coolant temperatures and cooling flows, but with the baffle removed, hot spots of 131° C. were found at the end windings. Consequently, the impingement cooling provided by the baffle provided a 23° C. reduction in end winding temperatures. By raising the coolant flow rate to 19 litres/minute, a maximum winding temperature of 97° C. could be achieved—a 34° C. reduction. As will be understood, for various applications, the maximum number of holes and the diameter of the holes could be adjusted to provide optimum cooling. Without wishing to be limited by theory, this increased coolant effectiveness is believed to result from the increased local flow velocity at the end winding surface caused by the apertures acting as nozzles, resulting in an increased heat transfer coefficient. Additionally, the high-velocity coolant jets create a thing boundary layer of coolant over the windings, thus increasing the surface area in contact with the high-velocity coolant, and reducing hot-spots.

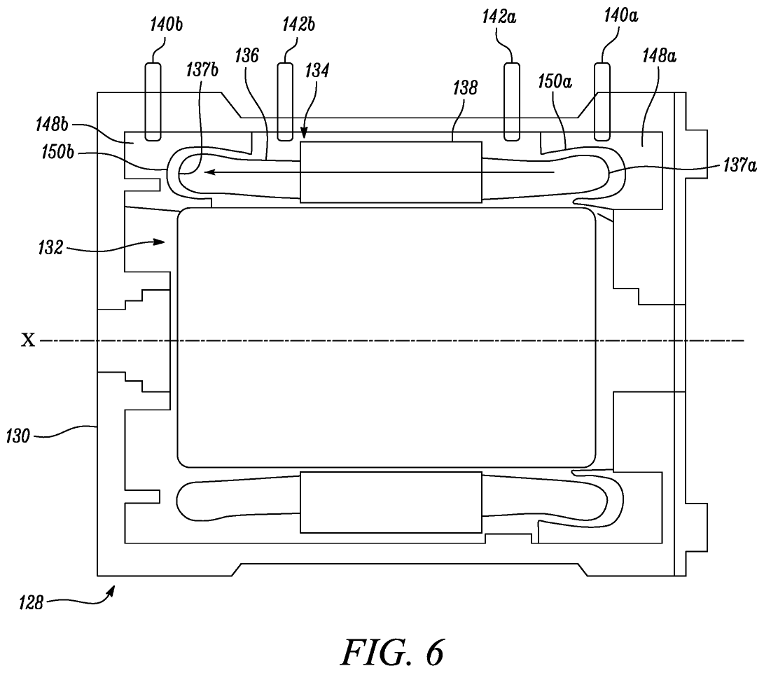

FIG. 6 shows a first alternative cooling arrangement for an electric machine in the form of a motor 128. The motor 128 is similar to the motor 28, having a rotor 132 and stator 134 comprising a core 138 and stator winding 136 provided within a housing 130. However, the arrangement of cooling inlets, outlets and baffles differs from that of the motor 28.

In the motor 128, first and second inlets 140a, 140b are provided, which communicate respectively with first and second outlets 142a, 142b. Each inlet 140a, 140b is provided at a respective axial end of the stator housing 130, and feeds into a respective inlet manifold 148a, 148b. Each inlet 140a, 140b is separated from its respective outlet 142a, 142b by a respective baffle 150a, 150b. The baffles 150a, 150b are similar to the baffle 50 of the first embodiment, having apertures (not shown) extending therethrough, to provide fluid communication between the respective inlets 140a, 140b and outlets 142a, 142b. Each baffle 150a, 150b is positioned adjacent a respective end winding 137a, 137b of the stator winding 136.

Consequently, in use, coolant (such as air or a liquid coolant) flows from respective inlets 140a, 140b into respective inlet manifolds 148a, 148b, through the apertures provided in the respective baffles 150a, 150b, whereupon the coolant flow impinges on the end windings 137a, 137b. Spent coolant is then directed out of respective outlets 142a, 142b.

Consequently, each end winding is actively cooled by impingement cooling, while the stator core 138 is not actively cooled by the coolant. Such a design may be appropriate where room can be provided for a coolant system at each end, and where temperatures of the uncooled stator core are acceptable in use.

In order to prevent leakage between the two ends of the stator, full vacuum impregnation of the stator winding may be utilised, to ensure that no fluid passage is provided through the central portion of the stator winding.

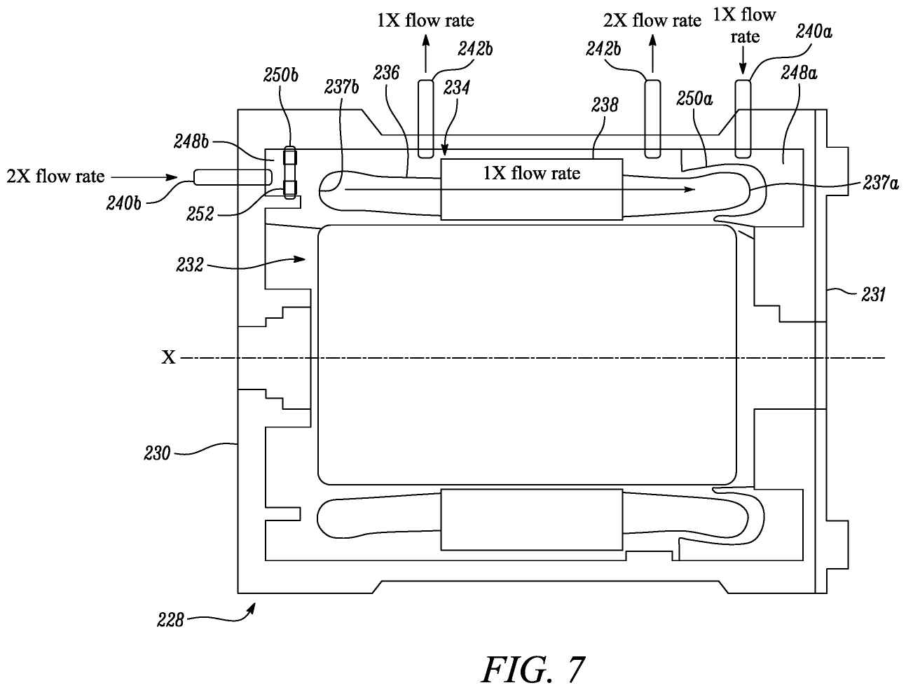

FIG. 7 shows a second alternative cooling arrangement for an electric machine in the form of a motor 228.

The motor 228 is again similar to the motors 28, 128, having a rotor 332 and stator 334 comprising a core 238 and stator winding 236 provided within a housing 230. The housing 230 comprises a drive plate 231 through which an axle extends. However, the arrangement of cooling inlets, outlets and baffles differs from that of the motors 28, 128.

In the motor 228, first and second inlets 240a, 240b are provided, which communicate respectively with first and second outlets 242a, 242b via respective baffles 250a, 250b. Each inlet 240a, 240b is provided at a respective axial end of the stator housing 230, and feeds into a respective inlet manifold 248a, 248b. The first inlet 240a is separated from its outlet 242a by a baffle 250a. The baffle 150a is similar to the baffles 50, 150 of the first and second embodiments, having apertures (not shown) extending therethrough, to provide fluid communication between the inlets 240a, and outlet 242a. The baffle 150a is positioned adjacent a first end winding 237a, of the stator winding 236, and extends around radially inner and outer sides of the end winding 237a.

The second end winding 237b is provided with a baffle 250b having a different form. The baffle 250b forms part of the housing, and is provided at the end of the motor opposite the drive plate 231. Again, apertures 252 are provided through the baffle 250b, which extend in a generally axial direction, toward the end winding 237b. Consequently, impingement cooling is provided in this location, though the impingement may be less effective, since coolant is provided in an axial direction only. As such, either reduced cooling effectiveness is achieved, or increased coolant flow is required.

In one embodiment, flow through the stator core 238 may be provided by providing a second inlet 240b and first outlet 242a having a larger diameter relative to the first inlet 240a and second outlet 242b. Coolant flow may be permitted through channels (not shown) in the stator core 238, resulting in the airflow shown in FIG. 7.

Such an arrangement allows for increased space in the stator housing for winding terminations on the non-drive end of the stator housing 230.

Consequently, in use, coolant (such as air or a liquid coolant) flows from respective inlets 140a, 140b into respective inlet manifolds 148a, 148b, through the apertures provided in the respective baffles 150a, 150b, whereupon the coolant flow impinges on the end windings 137a, 137b. Spent coolant is then directed out of respective outlets 142a, 142b.

It will be understood that the invention is not limited to the embodiments above-described and various modifications and improvements can be made without departing from the concepts described herein. For example, the electric machine may comprise a generator, such as the generator 20 driven by the gas turbine engine 22 of a propulsion system. The electric machine may be utilised in non-aerospace applications, or for non-propulsive purposes in an aircraft. Examples include fuel and hydraulic pumps.

Except where mutually exclusive, any of the features may be employed separately or in combination with any other features and the disclosure extends to and includes all combinations and sub-combinations of one or more features described herein.

1. An electric machine comprising:
a stator winding located within a stator housing;
the stator housing comprising an inlet chamber configured to communicate with a supply of coolant, and an outlet;
the stator housing comprising a baffle configured to separate the stator winding and outlet from the inlet chamber; wherein
the baffle comprises at least one aperture therethrough configured to supply an impingement flow of coolant to the stator winding.

2. An electric machine according to claim 1, wherein the baffle is provided adjacent an end winding of the stator.

3. An electric machine according to claim 2, wherein the baffle at least partly surrounds generally opposite sides of the end winding.

4. An electric machine according to claim 2, wherein the stator winding defines a channel through which coolant is configured to flow from the baffle to the outlet.

5. An electric machine according to claim 1, wherein a first outlet is provided adjacent a first end winding separated from a first inlet by a first baffle, and a second outlet is provided at second end winding separated from a second inlet by a second baffle.

6. An electric machine according to claim 5, wherein the first inlet is configured to provide a lower coolant flow rate in use relative to the second inlet.

7. An electric machine according to claim 5, wherein the first outlet is configured to pass a higher coolant flow rate in use relative to the second outlet.

8. An electric machine according to claim 5, wherein the winding defines a channel configured to communicate between the second inlet and first outlet.

9. An electric machine according to claim 1, wherein the or each aperture in the or each baffle comprises a nozzle configured to accelerate flow through the aperture.

10. An aircraft propulsion system comprising an electric machine in accordance with claim 1.

11. An aircraft propulsion system according to claim 10, wherein the electric machine comprises one or both of a generator and a motor.

12. An aircraft propulsion system according to claim 10, wherein the propulsion system comprises an internal combustion engine, and the generator is configured to be driven by the internal combustion engine.

13. An aircraft propulsion system according to claim 10, wherein the propulsion system comprises a propulsor, and the motor is configured to drive the propulsor.
